(19) United States
(12) Patent Application Publication
(10) Pub. No.: US 2008/0212615 A1
(43) Pub. Date: Sep. 4, 2008

(54) Method and Apparatus for Communicating Data in a Communications System

(76) Inventors: Karri Ranta-Aho, Espoo (FI); Juho Pirskanen, Tampere (FI); Harri Holma, Helsinki (FI)

Correspondence Address: DITTHAVONG MORI & STEINER, P.C., 918 Prince St., Alexandria, VA, 22314, US

(21) Appl. No.: 11/763,708

(22) Filed: Jun. 15, 2007

(30) Foreign Application Priority Data
Jul. 10, 2006 (EP) EP 06 014 289.0

(51) Int. Cl. H04J 3/00

(52) U.S. Cl. 370/498

(57) ABSTRACT

Disclosed are a user equipment and a communications node for communicating data in a communications system including a plurality of user equipments, as well as a method for communicating the data by a user equipment and a method for communicating data by a communications node, wherein data are transmitted from the communications node via a downlink shared channel and received by the user equipment. The user equipment comprises an acknowledger which provides uplink acknowledgements with respect to downlink shared channel transmission for user equipments without a dedicated connection which acknowledgements are received by an acknowledgement receiver included in the communications node. The uplink acknowledgements are transferred through a common uplink feedback channel.

### FIELD OF THE INVENTION

The invention, according to various embodiments, relates to communications, and particularly, to a user equipment and a communications node for communicating data in a communications system.

### BACKGROUND OF THE INVENTION

Current 3G systems use a method as defined in the first release (Release '99) of the standards for mobile communication which method is provided for transferring data packets to the user equipments (UEs) which do not maintain a dedicated connection. So, in such a case the user equipments do not operate within a dedicated channel state (CELL_DCH state). In this mechanism, the communications node called Node B uses a secondary common control physical channel (S-CCPCH) which carries a forward access channel (FACH) coming from a radio network controller (RNC). The RNC incorporates a user identification ID into the FACH data packets. All users which are in the CELL_FACH state listen to the S-CCPCH, decode the FACH data packets and check the user ID; and if they do not find their own ID, the message with the data packets is dropped.

A further development of the wideband code division multiple access (WCDMA)/universal mobile telecommunications system (UMTS) communication system defined by the 3GPP organization is the definition of the system known as high speed downlink packet access (HSDPA). HSDPA operates as a time shared communications channel which provides the potential for high peak data rates as well as the possibility for having a high spectral efficiency.

Current 3GPP HSDPA standards (e.g., 3GPP Release 5) define a high speed downlink shared channel (HS-DSCH), which is a downlink transport channel shared by several user equipments. The HS-DSCH is associated with one downlink dedicated physical channel (DPCH) per active user, and one or several high speed shared control channels (HS-SCCH). The HS-DSCH can be transmitted over the entire cell or over only part of the cell using for example beam-forming antennas.

HSDPA improves system capacity and increases user data rates in the downlink, in other words for transmission of data from a radio base station (RBS) which in a UMTS system is also known as a Node B server (and in the GSM by the term base transceiver station BTS) to the user equipment.

This improved performance is based on three aspects.

The first aspect is the use of adaptive modulation and coding. In HSDPA, the link adaptation entity in the radio base station (Node-B server) tries to adapt to the current channel conditions of a certain user equipment (or user terminal) by selecting the highest possible modulation and coding scheme keeping the frame error probability below a certain threshold. For that purpose, the user equipment periodically sends channel quality feedback reports to the respective serving RBS, which indicate the recommended transmission format for the next transmission time interval (TTI), including the recommended transport block size, the recommended number of codes and the supported modulation scheme as well as a possible power offset. The reported channel quality indicator (CQI) value is determined on the basis of measurements of a common pilot channel. In a typical implementation it is a pointer to an index in one of the tables specified in the document “3GPP TS 25.214—Physical Layer Procedures (FDD)” that define the possible transmission format combinations (as mentioned above) for different categories of user equipment (UE).

The second aspect is the provision of fast retransmissions with soft combining and incremental redundancy, so that should link errors occur the user equipment rapidly requests retransmission of the data packets. Whereas the standard WCDMA network specifies that the requests are processed by the radio network controller (RNC), in HSDPA the request is processed by the RBS. Furthermore the use of incremental redundancy, allows the selection of correctly transmitted bits from the original transmission and retransmission in order to minimize the need for further repeat requests when multiple errors occur in transmitted signals.

The third aspect of HSDPA is fast scheduling in the RBS. This is where data to be transmitted to the user equipment is buffered within the RBS prior to transmission and the RBS using a selection criteria selects some of the packets to be transmitted based on information about the channel quality, user equipment capability, the quality of service class and power/code availability. A commonly used scheduler is the so-called proportional fair (P-FR) scheduler.

HSDPA is an efficient method for delivering relatively large amounts of data in relatively small time periods (the TTI for a HSDPA system is 2 ms). This performance however can only be used when the user equipment is operating within a dedicated channel state (CELL_DCH state), i.e., after a physical layer connection between UE and the RBS has been established and the layer connection has dedicated channels allocated to it.

When the UE is in the process of changing state to the CELL_DCH state, the required state change has to be addressed to the UE by the forward access channel (FACH) which is significantly slower and less robust than the later HSDPA transmission channels.

It is also known to deliver data to a UE not in the dedicated channel (CELL_DCH) state by using the forward access channel (FACH) to deliver small amounts of data or control information to the UE.

If the downlink shared channel utilizes a high speed acknowledgement request (HARQ) mechanism, it requires a dedicated uplink feedback link for acknowledging the received data packets and possibly delivering other information about the receiver's situation. So, each user maintains a dedicated connection and delivers uplink acknowledgements for a HARQ re-transmission protocol and channel quality information for helping the scheduler using the HS-DPCCH. Accordingly, even though the downlink data are delivered over a shared connection, a dedicated link is used for uplink feedback as well as for delivering power control commands in the downlink to control the transmission power of that feedback channel.

Similar structures and methodologies are currently being defined for the 3GPP Long Term Evolution (LTE or 3.9G).

The 3GPP Release 6 defines a Multimedia Broadcast/Multicast Service (MBMS) feature which allows the UMTS terrestrial radio access network (UTRAN) to deliver broadcast-type data streams to user equipments. That is, the network transmits only a single stream of data which however may be received by a plurality of user equipments. A similar capability is also being defined for the 3GPP Long Term Evolution. This method for MBMS delivery relies on transmitting MBMS transport channels over the S-CCPCH channel the same way as the forward access channel (FACH) is used to deliver messages to a single user equipment. In both such cases, the Node B has no knowledge of the user(s) actually listening to the channel and receiving the message and does not have any means for receiving feedback of e.g., successful transmission from the user equipments.

Therefore, in summary, the prior art solutions are to use a shared channel and to have a dedicated feedback link for each potentional receiver, or not to use any feedback at all e.g., resulting in the loss of the HARQ gains.

### SUMMARY OF SOME EXEMPLARY EMBODIMENTS

Therefore, there is a need to provide an improvement which at least partially addresses the problem discussed above.

According to an embodiment of the invention, there is provided a user equipment for communicating data in a communications system including a plurality of user equipments, comprising a receiver for receiving data via a downlink shared channel, characterized by an acknowledger for providing uplink acknowledgments with respect to downlink shared channel transmissions for users without a dedicated connection.

According to another embodiment of the invention, there is provided a communications node for communicating data in a communications system including a plurality of user equipments, comprising a transmitter for transmitting data via a downlink shared channel, characterized by an acknowledgement receiver for receiving from user equipments uplink acknowledgements with respect to downlink shared channel transmissions for users without a dedicated connection.

According to another embodiment of the invention, there is provided a method, in a user equipment, for communicating data in a communications system including a plurality of user equipments, the method comprising: receiving data via a downlink shared channel, and providing uplink acknowledgements with respect to downlink shared channel transmissions for users without a dedicated connection.

According to another embodiment of the invention, there is provided a method, in a communications node, for communicating data in a communications system including a plurality of user equipments, said method comprising: transmitting data via a downlink shared channel; and receiving from user equipments uplink acknowledgements with respect to downlink shared channel transmissions for users without a dedicated connection.

According to another embodiment of the invention, there is provided a communications system including a plurality of user equipments according to the first aspect and further including at least one communications node according to the second aspect.

According to another embodiment of the invention, there is provided a method, in a communications system, including a method according to the third aspect and further including a method according to the fourth aspect.

According to another embodiment of the invention, there is provided a computer program comprising program code means adapted to perform a method according to the third aspect when the program is run on a processor in a user equipment.

According to another embodiment of the invention, there is provided a computer program comprising program code means adapted to perform a method according to the fourth aspect when the program is run on a processor in a communications node.

According to another embodiment of the invention, there is provided an integrated circuit in a user equipment for communicating data in a communications system including a plurality of user equipments, comprising a receiver for receiving data via a downlink shared channel, and an acknowledger for providing uplink acknowledgments with respect to downlink shared channel transmissions for user equipments without a dedicated connection via an uplink feedback channel.

According to yet another embodiment of the invention, there is provided an integrated circuit in a communications node for communicating data in a communications system including a plurality of user equipments, comprising a transmitter for transmitting data via a downlink shared channel, and an acknowledgement receiver for receiving from user equipments uplink acknowledgements with respect to downlink shared channel transmissions for user equipments without a dedicated connection via an uplink feedback channel.

The invention, according to certain embodiments of the invention, provides means for the user equipment to generate uplink acknowledgements, preferably fast uplink acknowledgements, to downlink shared channel transmissions for users without a dedicated connection. An advantage of the invention is to enable a more robust data transmission for users without a dedicated connection to the network in particular as HARQ can be utilized so that the invention allows the usage of the Node B based HARQ protocol for such users. Thus, there is no need for continuous uplink transmissions for all the users to which data are transmitted, but freed uplink capacities and freed communications node hardware resources are available for other purposes.

In particular, for FACH-like transmission the HARQ operating point can be adapted to the UE's channel conditions wherein the transmission can be carried out with a relatively high data rate (e.g., typically available in 50% of the cell radius) and repeated until receipt of an acknowledgement. In such a case, the effective data rate for the users being closer to the communications node (Node B) is higher since very few re-transmissions are needed than for users being in a cell edge.

The invention, in an exemplary embodiment, provides for a common uplink feedback channel for transferring the uplink acknowledgements. This concept of a common uplink feedback channel according to the invention can be generalized for any downlink share channel in any technology used to deliver data to users without a dedicated feedback link.

Further embodiments of the invention are defined in the dependent claims.

In one embodiment, the common uplink feedback channel is provided for any downlink shared channel adapted to transfer data to users without a dedicated feedback link.

The common uplink feedback channel is preferably configured to a cell which preferably supports the use of the HSDPA without a dedicated connection to the user equipment. This can be provided in cells which use the HSDPA in the CELL_FACH state.

An acknowledgement may be provided only unless the reception of data assigned to the user equipment alone or at least assumed to be assigned to it fails, such as in a FACH-like transmission. Unless such an acknowledgement is received, the data may be re-transmitted by the communications node. In such a case, the acknowledgement is used as a positive acknowledgement.

An acknowledgement may be provided only if the reception of data assigned to a plurality of predetermined user equipments or at least assumed to be assigned to them fails, as in a MBMS-like transmission. If such an acknowledgement is received, the data may be re-transmitted by the communications node. In such a case, the acknowledgement is used as a negative acknowledgement.

Alternatively, an acknowledgement may be provided only if the reception of data assigned to the user equipment alone or at least assumed to be assigned to it fails, as in a FACH-like transmission. If such an acknowledgement is received, the data may be re-transmitted by the communications node. In such a case, the acknowledgement is used as a negative acknowledgement.

An acknowledgement may be provided only unless the reception of data assigned to a plurality of predetermined user equipments or at least assumed to be assigned to them fails, as in a MBMS-like transmission. Unless such an acknowledgement is received, the communications node may re-transmit the data. In such a case, the acknowledgement is used as a positive acknowledgement.

Alternatively, an acknowledgement of a first kind may be provided only if the reception of data assigned to the user equipment alone or at least assumed to be assigned to it fails, and an acknowledgement of a second kind may be provided only if the reception of data assigned to a plurality of predetermined user equipments or at least assumed to be assigned to them fails. If such an acknowledgement of a first kind or such an acknowledgement of a second kind is received, the communications node may re-transmit the data.

Alternatively, an acknowledgement of a first kind may be provided only unless the reception of data assigned to the user equipment alone or at least assumed to be assigned to it fails, and an acknowledgement of a second kind may be provided only unless the reception of data assigned to the plurality of predetermined user equipments or at least assumed to be assigned to them fails. Unless such an acknowledgement of a first kind or such an acknowledgement of a second kind is received, the communications node may re-transmit the data.

Preferably, a plurality of simultaneous acknowledgments originating from a plurality of user equipments look like a single acknowledgement to the communications node.

The downlink shared channel is preferably a HS-DSCH.

Additionally, channel quality information may be provided, as in case of a FACH-like transmission. Preferably, the channel quality information are transferred through the common uplink feedback channel.

Preferably, the communications node serves as a radio base station.

Preferably, a communications system includes a plurality of user equipments and further includes at least one communications node. In a communications system being a cellular communications systems including a plurality of cells, one uplink resource may be allocated for each cell which resource is used for the provision of an acknowledgement via a common uplink feedback channel and is made known to all the users.

### BRIEF DESCRIPTION OF THE DRAWINGS

The invention will be readily understood by the following detailed description in conjunction with the accompanying drawings, wherein like reference numerals designate like structural elements, and in which

FIG. 1 shows a schematic view of a communications system within which various embodiments of the invention can be implemented;

FIG. 2 schematically shows a possible frame structure for the uplink HS-DPCCH according to an embodiment of the invention; and

FIG. 3 schematically shows a possible frame structure for the uplink HS-CPCCH according to an embodiment of the invention.

### DESCRIPTION OF THE PREFERRED EMBODIMENT

The invention is described herein by way of example with reference to a number of embodiments. The invention, according to certain embodiments, is described in the context of a cellular communications system and specifically to a HSDPA WCDMA/UMTS communications system. It is however understood that the invention may equally be capable of being implemented in any communications system wherein the provision of uplink acknowledgements to downlink shared channel transmission for uses without a dedicated connection is needed so that this concept can be generalized for any downlink share channel in any technology.

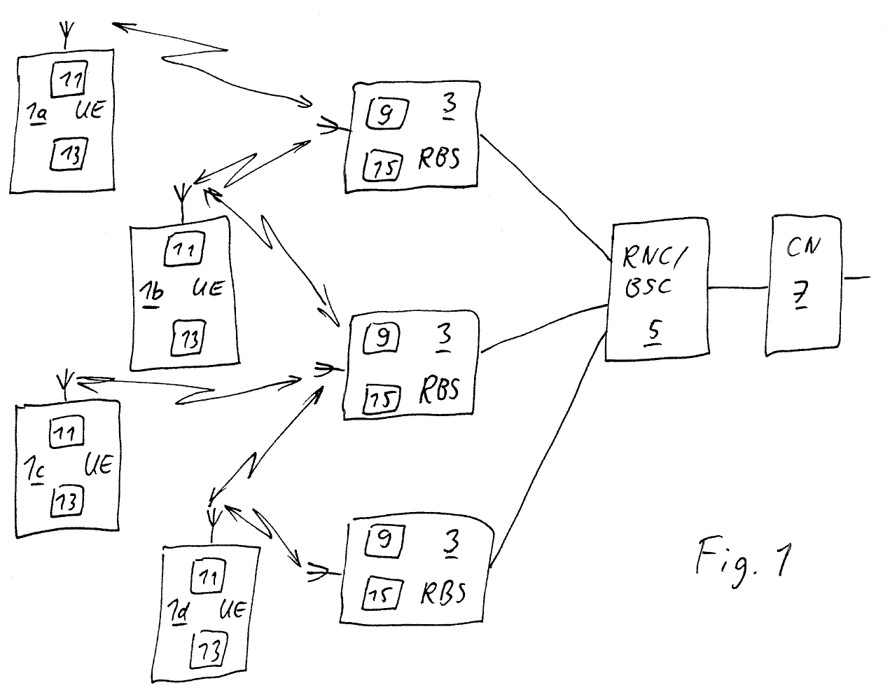

FIG. 1 shows a schematic view of a communications system within which various embodiments of the invention can be implemented. The system comprises at least one user equipment (UE) which can be for example a mobile telephone, but could also be for example a communication capable laptop, personal digital assistant, or any other suitable device. In FIG. 1 as an example shown are four user equipments 1a to 1d.

The user equipment 1a, 1b, 1c, 1d communicates wirelessly by radio with a series of radio base stations (RBS) 3. In FIG. 1 as an example shown are three radio base stations (RBS) 3. The radio base stations are also known in the UMTS standard as Node-B. In the following description the terms Node-B and radio base station (RBS) are to be used interchangeably.

Each user equipment 1a to 1d is arranged to be able to communicate to more than one RBS 3, and similarly each RBS 3 is arranged to be capable of communicating to more than one of the user equipments 1a to 1d. The RBS 3 further communicates with a radio network controller (RNC) 5 (which is also known in the GSM standard as a Base station controller (BSC)). The RNC 5 can further communicate to a core network (CN) 7. The CN 7 can further communicate with other networks, for example further public land mobile networks (PLMNs) or to the internet.

The user equipments 1a to 1d receive data packets such as HSDPA data packets transmitted from a serving RBS 3 in the downlink via a downlink shared channel such as HS-DSCH. Accordingly, each RBS 3 includes a transmitter 9 for transmitting such data packets, and each of the user equipments 1a to 1d includes a receiver 11 for receiving such data packets.

Moreover, each of the user equipments 1a to 1d includes an acknowledger 13 for providing uplink acknowledgements, preferably fast uplink acknowledgements, to the downlink shared channel transmissions for users without a dedicated connection. For transferring uplink acknowledgements a common shared uplink feedback channel is provided. For receiving such uplink acknowledgements, each RBS 3 further includes an acknowledgement receiver 15.

The receiver 11 and the acknowledger 13 and possibly further components not mentioned here can, for example, be integrated in an integrated circuit which is included in each of the user equipments 1a, 1b, 1c, 1d. Also the transmitter 9 and the acknowledgement receiver 15 and possibly further components not mentioned here can be integrated in an integrated circuit which is included in each RBS 3.

One uplink resource is allocated to each cell generated by each RBS 3. This resource which uses a mechanism to be used for the common uplink feedback signalling is made known to all the user equipments 1a, 1b, 1c, 1d either explicitly in the cell information broadcast to the cell or implicitly derived from other cell parameters or alternatively fixed in a suitable standard.

The common uplink feedback channel is configured to each cell which supports the use of the HSDPA without a dedicated connection to the user equipment 1a, 1b, 1c, 1d and, thus, uses the HSDPA in CELL_FACH state.

So, the user equipment 1a, 1b, 1c, 1d which does not maintain a dedicated link acknowledges the reception of a transmission using the common uplink feedback channel.

In the following, two examples of usage for data signalling will be described, e.g., one intended for a single user, and another one for a plurality of users.

In case only one user is targeted at one time, there may be one successful reception at any given time only (e.g., FACH-type transmission). The user equipment receiving a data packet intended to it alone can respond with a positive acknowledge message ACK. If the user equipment receives a data packet correctly and finds that it was intended to it, the acknowledger of this user equipment will send an ACK message through the common uplink feedback channel. If the user equipment does not receive a data packet correctly and thus cannot necessarily be sure if the transmission was intended to it or not, the user equipment does nothing so that its acknowledger does not provide any positive acknowledgement message. If the acknowledgement receiver in the serving RBS 3 does not receive an ACK message, this RBS 3 knows that the transmission was not received successfully by the receiver of the intended user equipment resulting in that the serving RBS 3 can re-transmit the data packet. So, the network at any given time either receives one ACK message from the user equipment it was transmitting a packet to, or does not receive anything. This can be considered as a shared ACK channel since only a single user is using the shared resource at any given time.

The other case is that a plurality of user equipments may expect a data packet intended for a plurality of users (e.g., MBMS-type transmission). The user equipments which receive a data packet intended to a plurality of users can respond with a negative acknowledgement message NACK. If the user equipment receives such a data packet correctly, it does nothing and awaits for the next data packet. If the receivers of all the intended user equipments receive the data packet correctly, there is no acknowledgement at all. So, in this case a correct reception is not acknowledged. If, however, at least one user equipment does not receive a data packet correctly, but finds that it was intended to it, it responds with a NACK message through the common uplink feedback channel. So, if the acknowledgement receiver 15 of the serving RBS 3 receives at least one NACK, the RBS 3 knows that there is at least one user equipment which has not received the data packet correctly so that the serving RBS 3 may re-transmit the data packet. There is no need to know if there are one or multiple NACKs. This can be considered as a common ACK/NACK channel since a plurality of user equipments may transmit a NACK simultaneously by using the same uplink resource. Therefore, in this case it is important that the design of the common uplink feedback channel is such that it allows a simultaneous transmission of NACKs for a plurality of user equipments without any conflict wherein the plurality of simultaneous NACKs originating from a plurality of user equipments look like a single NACK to the acknowledgement receiver 15 of the serving RBS 3. Moreover in this case, it is essential that the receivers of the user equipments are aware of in which TTIs the broadcast/multicast transmission takes place so that they know when they should send a NACK if a correct reception fails or even nothing has been received. With HSDPA this can be achieved by using an MBMS ID on the HS-SCCH indicated that the data channel is carrying a MBMS-like traffic. If this ID is detected on the control channel, but the data channel decoding fails, the user equipment knows that the transmission has failed so that its acknowledger can send a NACK.

In both cases described above as examples, it is sufficient for the acknowledgement receiver of the serving RBS 3 to know whether an ACK (e.g., in case of a FACH-like transmission) or a NACK (e.g., in case of a MBMS-like transmission) has been received. However, there is no need for the serving RBS 3 to identify the user equipment which provides the acknowledgement since the acknowledgement itself identifies the data packet which has a delivery failure and can be re-transmitted.

Additionally, the common uplink feedback channel can further be used to deliver channel quality information (CQI) at least in the case of a FACH-like transmission. In such a case, a CQI message can be embedded in the acknowledgement which helps the transmitter 9 of the serving RBS 3 to transmit subsequent data packets with a better accuracy.

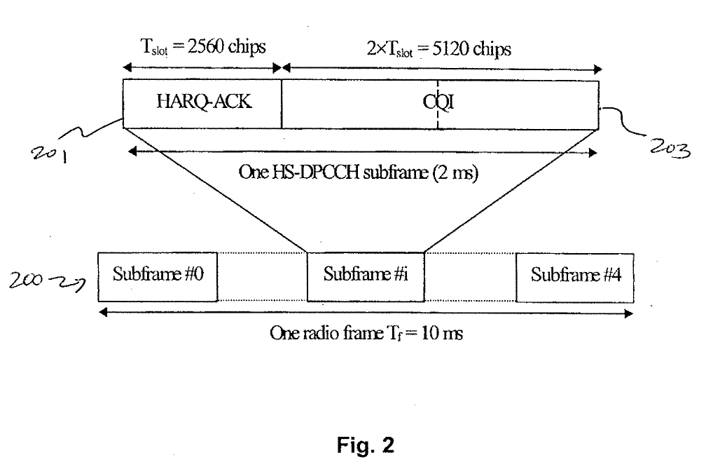

FIG. 2 shows the structure 200 of the HS-DPCCH as specified for the 3GPP Release-5 HSDPA according to an embodiment of the invention. A HARQ-ACK field 201 contains either 10 1-bits or 0-bits for the ACK/NACK transmission, respectively. A CQI field 203 carries a channel quality indication coded to 20 channel bits. Since the common uplink channel without a dedicated connection cannot be accurately power controlled, it may be beneficial to use more than one slot for the ACK/NACK transmission for better detection with a lower power. Due to the same reason the accurate timing cannot be controlled and the reception window in the network depends upon the air interface round trip delay. Allowing e.g., 100 km cell range requires 200 km round trip delay to be taken into account in the channel structure. This would lead to 1 slot long guard interval during which there should not be any transmission.

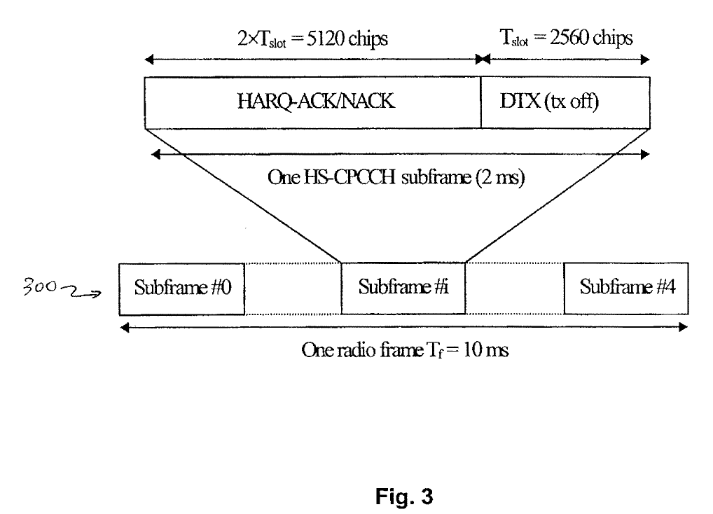

In FIG. 3 a possible frame structure 300 is shown for HS-CPCCH according to an embodiment of the invention. The ACK and NACK coding could be e.g., 20 1-bits or 20 0-bits, wherein nothing else needs to be transmitted than the single bit of information. The only thing the acknowledgement receiver 15 of the serving RBS 3 needs to know is whether or not there was a transmission. There is no need for any additional uplink pilot transmission as the ACK/NACK can be transmitted containing a known bit pattern (e.g., 20 1-bits). The acknowledgement receiver 15 can be a random-access-channel (RACH)-type receiver that is simply detecting the presence of the HS-CPCCH over the full timing window dictated by the cell range. For MBMS-like transmission where multiple NACKs may be sent simultaneously with very different arrival times, it is sufficient for the acknowledgement receiver 15 of the serving RBS 3 to detect a single tap reliably.

The used scrambling code must be cell specific as is the case with e.g., a physical random access channel (PRACH).

Each of the user equipments 1a, 1b, 1c, 1d and each of the RBS 3 can include a memory therein a computer program is sought which comprises program code means adapted to perform the above described methods, accordingly.

Finally, it should be noted that the above description is of certain examples for implementing embodiments of the invention, but the scope of the invention should not necessarily be limited by this description. It will be apparent to those skilled in the art that a person understanding this invention may conceive of changes or other embodiments or modifications, which utilize the principles of the invention without departing form the broader spirit and scope of the invention as set forth in the appended claims. All are considered within the scope of the invention.

1. A user equipment, comprising
a receiver for receiving data via a downlink shared channel, and
an acknowledger for providing uplink acknowledgments with respect to downlink shared channel transmissions for user equipments without a dedicated connection via an uplink feedback channel.

2. The user equipment according to claim 1, wherein the uplink feedback channel is provided for any downlink shared channel adapted to transfer data to user equipments without a dedicated feedback link.

3. The user equipment according to claim 1, wherein the uplink feedback channel is configured to a cell which supports the use of a high speed downlink packet access (HSDPA) without a dedicated connection to the user equipment.

4. The user equipment according to claim 1, wherein the acknowledger is adapted to provide an acknowledgment (ACK) only unless the reception of data assigned to the user equipment alone or at least assumed to be assigned to it fails, as in a forward-access-channel (FACH)-like transmission.

5. The user equipment according to claim 4, wherein the acknowledgement is a positive acknowledgement (ACK).

6. The user equipment according to claim 1, wherein the acknowledger (is adapted to provide an acknowledgement (NACK) only if the reception of data assigned to a plurality of predetermined user equipments or at least assumed to be assigned to them fails, as in a multimedia-broadcast/multicast-service (MBMS)-like transmission.

7. The user equipment according to claim 6, wherein the acknowledgement is a negative acknowledgement (NACK).

8. The user equipment according to claim 1, wherein the acknowledger is adapted to provide an acknowledgment only if the reception of data assigned to the user equipment alone or at least assumed to be assigned to it fails, as in a forward-access-channel (FACH)-like transmission.

9. The user equipment according to claim 8, wherein the acknowledgement is a negative acknowledgement.

10. The user equipment according to claim 1, wherein the acknowledger is adapted to provide an acknowledgement only unless the reception of data assigned to a plurality of predetermined user equipments or at least assumed to be assigned to them fails, as in a multimedia-broadcast/multicast-service (MBMS)-like transmission.

11. The user equipment according to claim 10, wherein the acknowledgement is a positive acknowledgement.

12. The user equipment according to claim 1, wherein the acknowledger is adapted to provide an acknowledgement of a first kind only if the reception of data assigned to the user equipment alone or at least assumed to be assigned to it fails, and to provide an acknowledgement of a second kind only if the reception of data assigned to a plurality of predetermined user equipments or at least assumed to be assigned to them fails.

13. The user equipment according to claim 1, wherein the acknowledger is adapted to provide an acknowledgement of a first kind only unless the reception of data assigned to the user equipment alone or at least assumed to be assigned to it fails, and to provide an acknowledgement of a second kind only unless the reception of data assigned to a plurality of predetermined user equipments or at least assumed to be assigned to them fails.

14. The user equipment according to claim 1, wherein the downlink shared channel is a high-speed downlink shared channel (HS-DSCH).

15. The user equipment according to claim 1, wherein the acknowledger is adapted to further provide channel quality information, as in case of a forward-access-channel (FACH)-like transmission.

16. The user equipment according to claim 1, wherein the uplink feedback channel is adapted to transfer the channel quality information.

17. A communications node, comprising
a transmitter for transmitting data via a downlink shared channel, and
an acknowledgement receiver for receiving from user equipments uplink acknowledgements with respect to downlink shared channel transmissions for user equipments without a dedicated connection via an uplink feedback channel.

18. The communications node according to claim 17, wherein the uplink feedback channel is provided for any downlink shared channel adapted to transfer data to user equipments without a dedicated feedback link.

19. The communications node according to claim 17, wherein the uplink feedback channel is configured to a cell which supports the use of a high speed downlink packet access (HSDPA) without a dedicated connection to the user equipment.

20. The communications node according to claim 17, wherein in case of a transmission of data to a predetermined single user equipment, as in a forward-access-channel (FACH)-like transmission, the transmitter is adapted to re-transmit said data unless the acknowledgement receiver receives an acknowledgment (ACK).

21. The communications node according to claim 20, wherein the acknowledgement is a positive acknowledgement (ACK).

22. The communications node according to claim 17, wherein in case of a transmission of data to a plurality of predetermined user equipments, as in a multimedia-broadcast/multicast-service (MBMS)-like transmission, the transmitter is adapted to re-transmit said data if the acknowledgement receiver receives an acknowledgement (NACK).

23. The communications node according to claim 22, wherein the acknowledgement is a negative acknowledgement (NACK).

24. The communications node according to claim 17, wherein in case of a transmission of data to a predetermined single user equipment, as in a forward-access-channel (FACH)-like transmission, the transmitter is adapted to re-transmit said data if the acknowledgement receiver receives an acknowledgement.

25. The communications node according to claim 24, wherein the acknowledgement is a negative acknowledgement.

26. The communications node according to claim 17, wherein in case of a transmission of data to a plurality of predetermined user equipments, as in a multimedia-broadcast/multicast-service (MBMS)-like transmission, the transmitter is adapted to re-transmit said data unless the acknowledgement receiver receives an acknowledgement.

27. The communications node according to claim 26, wherein the acknowledgement is a positive acknowledgement.

28. The communications node according to claim 17, wherein in case of a transmission of data to a predetermined single user equipment the transmitter is adapted to re-transmit said data if the acknowledgement receiver receives an acknowledgement of a first kind, and in case of a transmission of data to a plurality of predetermined user equipments the transmitter is adapted to re-transmit said data if the acknowledgement receiver receives an acknowledgement of a second kind.

29. The communications node according to claim 17, wherein in case of a transmission of data to a predetermined single user equipment the transmitter is adapted to re-transmit said data unless the acknowledgement receiver receives an acknowledgement of a first kind, and in case of a transmission of data to a plurality of predetermined user equipments the transmitter is adapted to re-transmit said data unless the acknowledgement receiver receives an acknowledgement of a second kind.

30. The communications node according to claim 17, wherein the uplink feedback channel is provided so that a plurality of simultaneous acknowledgments originating from a plurality of user equipments look like a single acknowledgement to the acknowledgement receiver.

31. The communications node according to claim 17, wherein the downlink shared channel is a high-speed downlink shared channel (HS-DSCH).

32. The communications node according to claim 17, wherein the acknowledgement receiver is adapted to further receive channel quality information, as in case of a forward-access-channel (FACH)-like transmission.

33. The communications node according to claim 17, wherein the uplink feedback channel is adapted to transfer the channel quality information.

34. The communications node according to claim 17, wherein the communications node is a radio base station (RBS).

35. A communications system including a plurality of user equipments according to claim 1.

36. The communications system according to claim 35, being a cellular communications system including a plurality of cells, wherein one uplink resource is allocated for each cell which resource is provided to be used for the provision of an acknowledgement via an uplink feedback channel and is made known to all the user equipments.

37. A method in a user equipment, the method comprising:
receiving data via a downlink shared channel, and
providing uplink acknowledgements with respect to downlink shared channel transmissions for user equipments without a dedicated connection via an up-link feedback channel.

38. The method according to claim 37, wherein the uplink feedback channel is provided for any downlink shared channel through which data are transferred to users without a dedicated feedback link.

39. The method according to claim 37, wherein the common uplink feedback channel is configured to a cell which preferably supports the use of a high speed downlink packet access (HSDPA) without a dedicated connection to the user equipment.

40. The method according to claim 37, wherein an acknowledgment (ACK) is provided only unless the reception of data assigned to the user equipment alone or at least assumed to be assigned to it fails, as in a forward-access-channel (FACH)-like transmission.

41. The method according to claim 40, wherein the acknowledgement is used as a positive acknowledgement (ACK).

42. The method according to claim 37, wherein an acknowledgement (NACK) is provided only if the reception of data assigned to a plurality of predetermined user equipments or at least assumed to be assigned to them fails, as in a multimedia-broadcast/multicast-service (MBMS)-like transmission.

43. The method according to claim 42, wherein the acknowledgement is used as a negative acknowledgement (NACK).

44. The method according to claim 37, wherein an acknowledgment is provided only if the reception of data assigned to the user equipment 1a, 1b, 1c, 1d) alone or at least assumed to be assigned to it fails, as in a forward-access-channel (FACH)-like transmission.

45. The method according to claim 44, wherein the acknowledgement is used as a negative acknowledgement.

46. The method according to claim 37, wherein an acknowledgement is provided only unless the reception of data assigned to a plurality of predetermined user equipments or at least assumed to be assigned to them fails, as in a multimedia-broadcast/multicast-service (MBMS)-like transmission.

47. The method according to claim 46, wherein the acknowledgement is used as a positive acknowledgement.

48. The method according to claim 37, wherein an acknowledgement of a first kind is provided only if the reception of data assigned to the user equipment alone or at least assumed to be assigned to it fails, and an acknowledgement of a second kind is provided only if the reception of data assigned to a plurality of predetermined user equipments or at least assumed to be assigned to them fails.

49. The method according to claim 37, wherein an acknowledgement of a first kind is provided only unless the reception of data assigned to the user equipment alone or at least assumed to be assigned to it fails, and an acknowledgement of a second kind is provided only unless the reception of data assigned to a plurality of predetermined user equipments or at least assumed to be assigned to them fails.

50. The method according to claim 37, wherein the downlink shared channel is a high-speed downlink shared channel (HS-DSCH).

51. The method according to claim 37, wherein channel quality information are additionally provided, as in case of a forward-access-channel (FACH)-like transmission.

52. The method according to claim 37, wherein the channel quality information are transferred through the uplink feedback channel.

53. A method in a communications node, said method comprising:
transmitting data via a downlink shared channel; and
receiving from user equipments uplink acknowledgements with respect to downlink shared channel transmissions for user equipments without a dedicated connection via an uplink feedback channel.

54. The method according to claim 53, wherein the uplink feedback channel is provided for any downlink shared channel through which data are transferred to user equipments without a dedicated feedback link.

55. The method according to claim 53, wherein the uplink feedback channel is configured to a cell which preferably supports the use of a high speed downlink packet access (HSDPA) without a dedicated connection to the user equipment.

56. The method according to claim 53, wherein in case of a transmission of data to a predetermined single user equipment, as in a forward-access-channel (FACH)-like transmission, said data are re-transmitted unless an acknowledgment (ACK) is received.

57. The method according to claim 56, wherein the acknowledgement is used as a positive acknowledgement (ACK).

58. The method according to claim 53, wherein in case of a transmission of data to a plurality of predetermined user equipments, as in a multimedia-broadcast/multicast-service (MBMS)-like transmission, said data are re-transmitted if an acknowledgement (NACK) is received.

59. The method according to claim 58, wherein the acknowledgement is used as a negative acknowledgement (NACK).

60. The method according to claim 53, wherein in case of a transmission of data to a predetermined single user equipment, as in a forward-access-channel (FACH)-like transmission, said data are re-transmitted if an acknowledgement is received.

61. The method according to claim 60, wherein the acknowledgement is used as a negative acknowledgement.

62. The method according to claim 53, wherein in case of a transmission of data to a plurality of predetermined user equipments, as in a multimedia-broadcast/multicast-service (MBMS)-like transmission, said data are re-transmitted unless an acknowledgement is received.

63. The method according to claim 62, wherein the acknowledgement is used as a positive acknowledgement.

64. The method according to claim 53, wherein in case of a transmission of data to a predetermined single user equipment said data are re-transmitted if an acknowledgement of a first kind is received, and in case of a transmission of data to a plurality of predetermined user equipments said data are re-transmitted if an acknowledgement of a second kind is received.

65. The method according to claim 53, wherein in case of a transmission of data to a predetermined single user equipment said data are re-transmitted unless an acknowledgement of a first kind is received, and in case of a transmission of data to a plurality of predetermined user equipments said data are re-transmitted unless an acknowledgement of a second kind is received.

66. The method according to claim 53, wherein a plurality of simultaneous acknowledgments originating from a plurality of user equipments look like a single acknowledgement.

67. The method according to claim 53, wherein the downlink shared channel is a high-speed downlink shared channel (HS-DSCH).

68. The method according to claim 53, wherein channel quality information are additionally received, as in case of a forward-access-channel (FACH)-like transmission.

69. The method according to claim 53, wherein the channel quality information are transferred through the uplink feedback channel.

70. The method according to claim 53, wherein the communications node serves as a radio base station (RBS).

71. The method, in a communications system, including a method according to claim 37.

72. The method, in a communications system including a plurality of cells, according to claim 71, wherein one uplink resource is allocated for each cell which resource is used for the provision of an acknowledgement via an up-link feedback channel and is made known to all the user equipments.

73. A computer program comprising program code means adapted to perform a method according to claim 37 when the program is run on a processor in the user equipment.

74. A computer program comprising program codes means adapted to perform a method according to claim 53 when the program is run on a processor in the communications node.

75. An integrated circuit in a user equipment, comprising
a receiver for receiving data via a downlink shared channel, and
an acknowledger for providing uplink acknowledgments with respect to downlink shared channel transmissions for user equipments without a dedicated connection via an uplink feedback channel.

76. An integrated circuit in a communications node comprising
a transmitter for transmitting data via a downlink shared channel, and
an acknowledgement receiver for receiving from user equipments uplink acknowledgements with respect to downlink shared channel transmissions for user equipments without a dedicated connection via an uplink feedback channel.
